(19) United States
(12) Patent Application Publication
(10) Pub. No.: US 2003/0233847 A1
(43) Pub. Date: Dec. 25, 2003

(54) Manufacture of elongated fused quartz member

(76) Inventor: Elmer G. Fridrich, Chardon, OH (US)

Correspondence Address: John F. McDevitt, 2255 Par Lane #626, Willoughby Hills, OH, 44094, US

(21) Appl. No.: 10/447,881

(22) Filed: May 30, 2003

Related U.S. Application Data
(60) Provisional application No. 60/389,667, filed on Jun. 19, 2002.

(51) Int. Cl. C03B 17/04

(52) U.S. Cl. 65/126

(57) ABSTRACT

An elongated fused quartz member is disclosed having alkali metal impurities being removed therefrom when initially formed. The impurities are removed by an electrolytic procedure accompanying formation of the elongated fused quartz member. Apparatus for carrying out the electrolytic removal procedure is also disclosed.

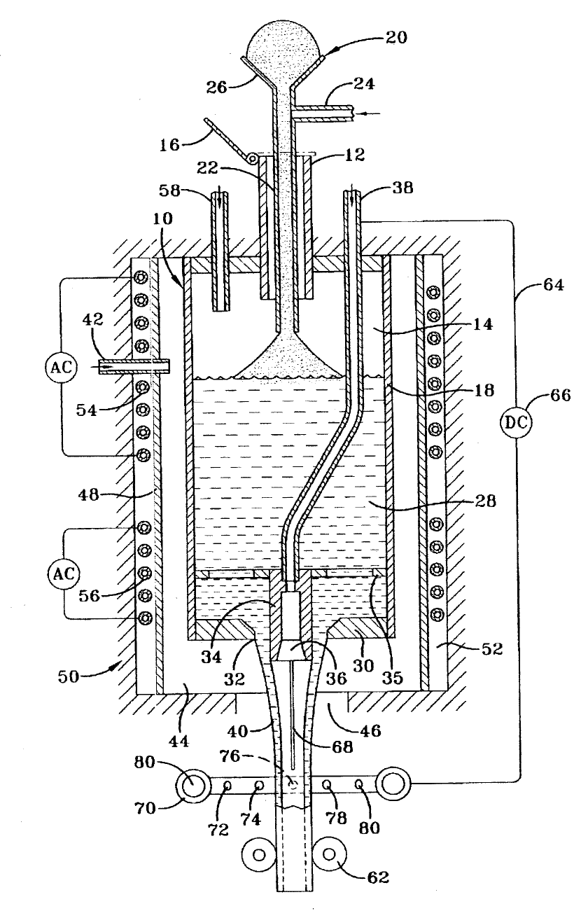

### RELATED PROVISIONAL APPLICATION

This application relates to Provisional Application Serial No. 60/389,667 filed by the present applicant: on Jun. 19, 2002.

### BACKGROUND OF THE INVENTION

The present invention relates generally to removing trace amounts of alkali metal impurities from an elongated fused quartz member by electrolytic action and more specifically to doing so in an improved manner when said fused quartz member is initially formed in a fluid condition.

Various elongated fused quartz member have been formed continuously by melting a pure grade of quartz crystal or sand in an electrically heated furnace whereby the desired shape is drawn from the furnace through a suitable orifice or opening in the bottom of the furnace as the raw material is being melted. In a known method and apparatus more fully described in U.S. Pat. No. 3,7641,286 there is disclosed an electrically conductive crucible of tungsten and molybdenum which is supported vertically and includes a suitable orifice or die at the bottom to draw cane, ribbon or tubing. Said crucible is induction heated with the fused quartz material being continuously drawn therefrom through suitable forming means in the presence of an atmosphere containing hydrogen and a non-oxidizing carrier gas.

It is further known that even trace amounts of alkali metal impurities in the elongated fused quartz member prove harmful in various end-use applications requiring the contaminated material to be substantially reheated. For example, in U.S. Pat. No. 3,425,767 it is disclosed that electric lamps having such contaminated fused quartz material for the lamp envelope experience premature failure which is caused by migration of these impurities during lamp operation. The method employed in said prior art patent to reduce such lamp failures during lamp operation applies a high voltage DC potential to a particularly constructed lamp for removal of these impurities prior to final lamp assembly. In doing so, the DC potential is described to be applied between a lead-in wire and a portion of the exhaust tube employed in said lamp with the impurities migrating to said exhaust tube portion for subsequent disposal. It is similarly known that fused quartz tubing and still other shapes formed with fused quartz tubing and/or rod which are employed to contain semiconductor materials; and devices during manufacture that even a trace amount of alkali metal contamination is deleterious. Such trace amounts of alkali impurities diffusing from the quartz furnace will degrade the semiconductor material. Reheating of fused quartz material contaminated with even trace amounts of these alkali metal impurities is thereby to be similarly avoided in the manufacture of semiconductor products.

### SUMMARY OF THE INVENTION

It has now been discovered, surprisingly, that trace amounts of alkali metal impurities can be essentially eliminated from an elongated fused quartz member in an unexpectedly superior manner. More particularly, said contaminated fused quartz member is subjected to a particular electrolytic procedure when initially formed and which can be carried out in a continuous uninterrupted mode of manufacture. Basically, the presently improved method removes these impurities when the article is being initially drawn at elevated temperatures from an electrically conductive metal furnace by applying a high voltage DC potential to the still heated fused quartz member with spaced apart anode and cathode electrodes while having the fused quartz member interposed therebetween. Application of the high voltage DC potential in such manner causes the alkali metal impurities in the elongated fused quartz member being drawn to migrate to the outer quartz member surface with said impurities being concurrently removed from said outer quartz member surface in a gaseous plasma environment for dissipation into the surrounding exterior atmosphere. In the required electrode arrangement, the impurity ions being removed are driven from the intervening quartz material to the cathode member which is physically spaced apart from said fused quartz member. Various configurations for the anode component in the present electrode arrangement are contemplated to produce such electrolytic action. When fused quartz tubing is being drawn according to the present method, a suitable anode electrode can be physically disposed within the central hollow cavity of said tubing at approximately the same elevation as the externally disposed cathode electrode. A similar anode arrangement can be employed when continuously forming a solid fused quartz rod or ribbon by having the anode electrode entirely enveloped within the fluid material, such as with a suspended wire extending downward from the bottom opening in the electrically conductive metal furnace. Alternately, it is further contemplated that said furnace itself can be suitably further modified to serve as the anode electrode in the present electrode arrangement. Such an electrode arrangement would connect the anode and cathode electrode members electrically connected across a high voltage DC power supply with the exterior cathode electrode being positioned nearby the electrically conductive melting furnace while a conventional core assembly in said furnace can serve as the inner anode electrode. A suitable cathode electrode member in the present electrode arrangement can also have different physical configurations. An electrically conductive gas burner generating the required gaseous plasma environment may prove adequate for this purpose. On the other hand, an electrically conductive hollow ring member provided with multiple gas burners to surround the elongated fused quartz member while being drawn is expected to serve the function of the cathode. A still different cathode member construction again employs said electrically conductive bottom ring member but replaces the multiple gas burners with sharp pointed inner projecting pins and a local shroud of argon gas to produce said gaseous plasma environment when disposed in close proximity to the outer walls of the moving fused quartz member.

The present method is further required to maintain such cathode plasma condition for effective impurity removal. More particularly, it is said cathodic plasma condition which causes these impurities to be displaced from the outer surface of the moving heated fused quartz member for dissipation into the surrounding atmosphere. A satisfactory cathodic plasma condition can also be provided by various neans. For example, a gas burner serving as the cathode member can produce a flame for impingement of the outer fused quartz surface to satisfy this requirement in the present method. A suitable gaseous plasma for this requirement can also be formed by surrounding the cathode member during operation with an inert gas, such as argon and the like. Accordingly, the above illustrated hollow ring configuration for said cathode member can be replaced by a shroud containing sharp point projections and enclosing argon gas. It will also be apparent to the skilled artisan that a suitable continuous cathodic plasma condition can be generated by still other means than herein mentioned.

It is an important object of the present invention, therefore, to provide a still more effective means to remove alkali metal impurities from an elongated fused quartz member.

It is another important object of the present invention to provide a novel method to remove trace amounts of said alkali metal impurities from an elongated fused quartz member.

Still another important object of the present invention is to provide a novel apparatus for continuously removing trace amounts of alkali metal impurities from a fused quartz member when initially formed.

A still further important object of the present invention is to provide a novel fused quartz member essentially devoid of trace amounts of alkali metal impurities as formed.

These and still further objects of the present invention will become more apparent upon considering the following more detailed description of the present invention.

### BRIEF DESCRIPTION OF THE DRAWING

The accompanying drawing, which accompanies and forms part of the specification, depicts a representative furnace apparatus which can be employed to continuously form an elongated fused quartz member of the present invention.

### DETAILED DESCRIPTION OF THE PREFERRED EMBODIMENTS

Referring to the accompanying drawing, there is depicted a longitudinal sectional view for a representative furnace construction according to the present invention. More particularly, said apparatus includes an elongated cylindrical melting crucible member 10 which is suitably constructed of a refractory metal, such as tungsten or molybdenum, and into which a purified quartz raw material is fed through a top opening 12 into an upper melting zone 14 of said crucible member. Said top opening 12 is provided with movable closure means 16, such as a trap door which can be kept closed except for observing the level of the melt 18 and during feeding of the raw material into the crucible. Automatic feeder means 20 are provided at said top opening of the crucible member to maintain a predetermined level of the raw material in the crucible. Said feeder means includes a discharge 22 having its outlet opening located within said crucible so as to provide the raw material in the upper zone where melting takes place, a purge gas inlet tube 24 and reservoir means 26 which contains a supply of the raw material being fed automatically to the discharge tube. Simple gravity flow of the raw material to the melting zone of the crucible member takes place as the melt level in the crucible drops with fusion of the sand particles so that it becomes unnecessary to incorporate any further means to adjust the rate of feeding the raw material as described. The purge gas being supplied to the feeder helps eliminate gases contained in the raw material which could otherwise oxidize the refractory metal components of the crucible member or form bubbles in the fused quartz melt which cannot thereafter be removed or minimized. The composition of said purge gas is the same or similar to that admitted elsewhere to the upper zone of said crucible member for the purpose of reducing bubbles and ridges in the final product and which consists of a gas mixture of hydrogen and helium in the volume ratios 40-65% hydrogen and 60-35% helium.

The lower portion of said crucible member includes an annular ring 30 having central opening 32 through which the elongated fused quartz member is continuously formed by drawing the viscous material through said opening. A core 34 is centrally disposed in the opening 32 and extends below the annular ring as the means of forming tubing from the viscous material being drawn from the melt. Support means 35 are affixed to the wall of the crucible and provide rigid support of the core which helps to maintain a constant size opening from which the product is being drawn. The core is fabricated with a hollow interior 36 which is connected to inlet pipe 38 so that supply of non-oxidizing gas having a different composition than supplied to the melting zone of the crucible can be furnished as a forming atmosphere while the tubing 40 is being drawn. A second inlet pipe 42 supplies the same type forming atmosphere which can be a mixture containing hydrogen in a non-oxidizing carrier gas such as nitrogen in volume ratios 1-20% hydrogen and 99-80% carrier gas as a protective atmosphere which surrounds the exterior wall of the crucible. This supply of forming gas is provided to annular space 44 which provides a housing means for the crucible and includes a central bottom opening 46 providing exhaust means from said cavity for the forming gas in a manner which envelopes the exterior surface of the elongated fused quartz member being drawn from the furnace. The exterior wall of said annular space comprises a refractory cylinder 48 which in combination with exterior housing 50 of the furnace construction serves as the container means for the induction heating coils of the apparatus. More particularly, a concentric passageway 52 is defined between the exterior wall of refractory cylinder 48 and the interior wall of housing 50 in which is disposed two helical-shaped induction heating coils 54 and 56 supplying separate heating sources for the upper and lower zones of the crucible, respectively. Said heating sources and the power supplies thereto can be of conventional construction which include electrical conductors that are hollow for water cooling being electrically connected to separate A.C. power supplies for the independent heating utilized in the operation of the illustrated furnace. The remainder of the passageway occupied by said coils is preferably packed with a stable refractory insulation such as zirconia in order to conserve heat in the furnace construction. A third supply pipe 58 is located in the top section of exterior housing 50 and supplies the same or similar purge gas mixture to the melting zone of the crucible as provided by inlet pipe 24. The above described furnace construction operates in a continuous manner to form the fused quartz tubing member 40 being drawn therefrom by a pair of conventional motor driven rolls 62.

In operation, said furnace construction further includes representative electrical circuit means 64 enabling removal of alkali metal contamination in the fused quartz tubing while being drawn. Specifically, the connection of inlet pipe 38 to a conventional high voltage DC power supply 66 (not further shown) allows core member 34 to serves as the anode component in said electrical circuit. The anode member further includes of a thin refractory metal wire 68 suspended downwardly from core member 34 into the hollow inner cavity of fused quartz member 40 after emerging from said furnace construction. A hollow ring burner member 70 surrounding the still fluid fused quartz tubing being continuously drawn is also connected to the same DC power supply for completion of the electrical circuit and serves as the cathode component in the illustrated electrolytic procedure. As can be noted in the present drawing, both electrode members are also physically disposed at approximately the same elevation for enhanced removal of the alkali metal impurities. Said cathode electrode member 70 includes a plurality of conventional electrically conductive gas burners 72-80 equispaced about the ring circumference for impingement of the flames issuing therefrom to provide electrical conduction to the outer surface of the moving fused quartz member. Said burner flames further generate a gaseous plasma environment adjacent the cathode member during circuit operation which enables the desired impurity removal to take place. In doing so, said alkali metal impurities are caused to migrate to the outer fused quartz surface under influence of the high voltage DC potential being applied and with the greatest voltage drop expected to occur across the intervening quartz material. Cooperating gas flames from the herein illustrated cathode member concurrently remove said impurities from the outer quartz surface for dissipation in the surrounding heated atmosphere. As not shown in the present drawing, the depicted cathode member 70 can further be replaced by projecting sharp points and further supplied with argon gas, when carrying out the electrolytic removal procedure of the present invention. The presence or substitution of such readily ionizable gases for the required cathode plasma is thereby contemplated in conducting the herein described impurity removal procedure.

While a preferred mode contemplated by the applicant for carrying out the present invention has been set forth above, it will be understood that additions, changes and modifications may be made thereto by those skilled in the art without departing from the spirit and scope of the invention as defined in the appended claims. For example, it will be apparent that an entirely dissimilar electrically conductive metal fusion furnace than herein specifically described can be utilized for the purpose of forming the elongated fused quartz member. Likewise, different gases can be substituted in said fusion furnace as well as for producing the cathodic plasma required in carrying out the present invention. It will be understood, therefore, that the present invention is limited only by the scope afforded to the following claims.

What I claim as new and desire to secure by Letters Patent of the United States is:

1. A method to remove alkali metal impurities from an elongated fused quartz member while being initially drawn in a fluid condition which comprises:
(a) drawing said fluid fused quartz member from a bottom opening provided in an electrically conductive metal furnace at elevated temperatures,
(b) applying a high voltage DC potential to said fluid fused quartz member while being drawn to cause said alkali metal impurities to migrate to the outer quartz member surface, and
(c) concurrently removing said alkali metal impurities from said outer quartz member surface in a gaseous plasma environment for dissipation in the surrounding exterior atmosphere.

2. The method of claim 1 wherein said high voltage DC potential is applied to the heated fused quartz member with spaced apart anode and cathode electrode members while having the fused quartz member interposed therebetween.

3. The method of claim 2 wherein the anode electrode member is internally disposed with respect to said fused quartz member and the cathode electrode member is, disposed externally with respect thereto.

4. The method of claim 2 wherein said connected anode and cathode electrode members are physically disposed at approximately the same elevation.

5. The method of claim 2 wherein the cathode electrode member is physically spaced apart from the fluid quartz member.

6. The method of claim 2 wherein the anode electrode member is physically disposed within the inner walls of fluid fused quartz tubing.

7. The method of claim 6 wherein the bottom opening of the electrically conductive metal furnace includes the anode electrode member.

8. The method of claim 7 wherein the anode electrode member extends downward from the bottom opening in the electrically conductive furnace.

9. The method of claim 1 wherein said gaseous plasma environment occurs between the cathode and fluid quartz member.

10. The method of claim 9 wherein said gaseous plasma environment is produced with an inert gas.

11. The method of claim 1 wherein the high voltage DC potential is applied so as to cause greatest voltage drop in the fluid quartz member.

12. A method to remove alkali metal impurities from fused quartz tubing while being initially drawn in a fluid condition which comprises:
(a) drawing said fluid fused quartz tubing from a heated electrically conductive metal crucible having a bottom die construction,
(b) further having an anode electrode member disposed within the hollow central cavity of the fluid fused quartz tubing while being drawn which cooperates with a cathode electrode member disposed externally of the fluid tubing walls, said electrode members being electrically connected across a high voltage DC power supply,
(c) applying said high voltage DC potential between said electrode members causing said alkali metal impurities to migrate to the outer surface of the fluid tubing walls, and
(d) concurrently removing said alkali metal impurities from the outer surface of said fluid tubing walls in a gaseous plasma environment for dissipation in the surrounding exterior atmosphere.

13. The method of claim 12 wherein said gaseous plasma environment occurs adjacent the cathode electrode member.

14. The method of claim 12 wherein the greatest voltage drop occurs within the fluid quartz tubing.

15. The method of claim 12 wherein the bottom die construction serves as the anode electrode member.

16. A method to remove alkali metal impurities from fused quartz rod while being initially drawn in a fluid condition which comprises:
(a) drawing said fluid fused quartz rod from a heated electrically conductive metal crucible having a bottom opening,
(b) further having an anode electrode member disposed within the body of the fluid fused quartz rod while being drawn which cooperates with to a cathode electrode member disposed externally of the fluid quartz rod, said electrode members being electrically connected to a high voltage DC power supply,
(c) applying said high voltage DC potential between said electrode members causing said alkali metal impurities to migrate to the outer surface of the fluid quartz rod, and
(d) concurrently removing said alkali metal impurities from the outer surface of said fluid quartz rod in a gaseous plasma environment for dissipation in the surrounding exterior atmosphere.

17. The method of claim 16 wherein a gaseous plasma environment occurs adjacent the cathode electrode member.

18. The method of claim 16 wherein the greatest voltage drop occurs within the fluid quartz rod.

19. A fused quartz melting apparatus to remove alkali metal impurities from an elongated fused quartz member while being initially drawn therefrom in a fluid condition which comprises:
(a) an electrically conductive metal crucible in which the fused quartz material is melted and continuously drawn therefrom at elevated temperatures from a bottom opening provided in said crucible,
(b) drawing means to continuously remove the fluid quartz member emerging from said crucible, and
(c) electrode means connected to a high voltage DC power supply which concurrently removes said alkali metal impurities from the moving fluid fused quartz member in a gaseous plasma environment before engagement by said drawing means.

20. The apparatus of claim 19 wherein said electrode means comprise spaced apart anode and cathode electrode members while having the fused quartz member interposed therebetween.

21. The apparatus of claim 20 wherein the anode electrode member is internally disposed with respect to said fused quartz member and the cathode electrode member is disposed externally with respect thereto.

22. The apparatus of claim 21 wherein said anode and cathode electrode members are physically disposed at approximately the same elevation.

23. The apparatus of claim 21 wherein the cathode Electrode member is physically spaced apart from the moving fluid fused quartz member.

24. The apparatus of claim 21 wherein the anode electrode member is physically disposed within the inner walls of fluid fused quartz tubing.

25. The apparatus of claim 19 wherein the bottom opening of the crucible includes the anode electrode member.

26. The apparatus of claim 20 wherein the anode electrode member extends downward from the bottom crucible opening.

27. The apparatus of claim 19 wherein said gaseous plasma environment occurs adjacent the cathode electrode member.

28. The apparatus of claim 19 wherein said gaseous plasma environment is produced with an inert gas.

29. The apparatus of claim 19 wherein greatest voltage drop occurs in the moving fluid quartz member.

30. The apparatus of claim 19 wherein the bottom crucible opening forms tubing.

31. The apparatus of claim 19 wherein the bottom crucible opening forms rod.

32. An elongated fused quartz member having alkali metal impurities removed therefrom by electrolytic means when said fused quartz member is initially formed in a fluid condition.

33. The elongated fused quartz member of claim 32 in the form of tubing.

34. The elongated fused quartz member of claim 32 in the form of rod.
